(19) United States
(12) Patent Application Publication
(10) Pub. No.: US 2012/0031065 A1
(43) Pub. Date: Feb. 9, 2012

(54) Agricultural Machine to Rake Agricultural Products

(75) Inventor: Carletto Tonutti, Tricesimo (IT)

(73) Assignee: Tonutti Wolagri Spa Con Socio Unico, Remanzacco (IT)

(21) Appl. No.: 13/265,478

(22) PCT Filed: Apr. 22, 2010
(86) PCT No.: PCT/IB2010/000913

§ 371 Date: Oct. 20, 2011

(30) Foreign Application Priority Data
Apr. 23, 2009 (IT) UD2009A000081

(51) Int. Cl. A01D 78/04

(52) U.S. Cl. 56/367

(57) ABSTRACT

An agricultural machine to rake a mass of hay, or other agricultural product, including at least a trailer-mounted frame, and an arm on which a plurality of operating tools are rotatably mounted. The arm is constrained to the frame so as to selectively move between a first operating condition in which the operating tools are in cooperation with the ground, and a second inactive condition in which the operating tools are raised from the ground in a position substantially parallel to the ground itself. The agricultural machine includes articulation members, interposed between the frame and the arm and includes a first positioning portion attached to the frame and a second positioning portion to which the arm is constrained. The first positioning portion and the second positioning portion are pivoted with respect to each other by elements of an articulation pin, in order to move the arm between the two conditions, operating and inactive.

### FIELD OF THE INVENTION

The present invention concerns an agricultural machine of the type able to be pulled by a tractor, to rake a mass of hay, fodder or other agricultural products, and to gather it together tidily in one or more tiers. In particular, the agricultural machine according to the present invention comprises a frame on which a plurality of star-shaped wheels are mounted rotatable, and exert an elastic thrust on the hay in order to gather it up. The agricultural machine according to the present invention allows to vary the disposition of the star-shaped wheels with respect to the ground, between a first lowered operating position in substantial contact with the ground, and an inactive or transport position, raised from the ground.

### BACKGROUND OF THE INVENTION

Agricultural machines called swathers are known, used to form tiers of hay after mowing.

Known swathers comprise a trailer-mounted frame able to be connected to a tractor and provided with a plurality of operating tools, or wheels, so-called star-shaped.

Each wheel consists of a plurality of radial teeth which carry out an action of elastic thrust on the hay, to form a tier.

Frames are known in which the wheels are disposed in sequence on a plurality of arms constrained to the frame.

It is also known that a support bar is constrained to each arm of the frame, on which a plurality of wheels are assembled, so as to convey the hay toward the centre of the swather and then to form a central tier.

Machines are also known in which the arms with the relative wheels can be selectively moved from a first operating condition in which the arms protrude laterally from the frame and the wheels contact the ground, and a second inactive or transport position, in which the arms are substantially comprised in the bulk of the frame and keep the wheels in a position raised from the ground.

In particular, there is an ever growing need in the field to provide that the unit consisting of the support bar and the wheels, in the second transport position, is disposed substantially parallel to the ground.

However, this substantially parallel disposition is not easily achievable, in that, in an operating condition, the support arms and the wheels define a determinate operating angle with respect to each other so as to form the tier.

A solution is known in which each arm is pivoted to the frame, and a tie rod element is provided attached to the frame and to the support bar.

During the rotation of the arm, the tie rod element conditions the position of the support bar with respect to the arm, progressively varying the position of the wheels, until they reach a position substantially parallel to the ground.

This known solution, in order to determine the conditioned positioning of the support bar, needs the bar to be able to oscillate coplanar to the arm, allowing only two degrees of freedom for the regulation of the position of the wheels with respect to the ground in the first operating condition. This limits the potential operativeness of the known machine.

Moreover, this known solution needs a shock absorbing mechanism to thrust the arm with respect to the frame. As is known, this type of shock absorption is of very little advantage mechanically, above all because of the stresses the various components are subjected to.

A solution is also known in which the articulation pin which determines the pivoting of the arm on the frame is mounted directly on the frame in an inclined condition, that is, with its pivoting axis inclined both with respect to a substantially vertical plane and also with respect to a substantially horizontal plane.

This known solution, having the articulation pin mounted directly inclined with respect to the frame, and as the arm and the frame are substantially orthogonal to each other, determines a position of the arm which is not orthogonal with respect to the articulation pin. Therefore, particular conformations and oversizing of the articulation pin are needed, with consequent increase in production costs.

In this known solution there are not always balanced stresses between the parts: such stresses determine non-uniform wear with consequent kinematic disadvantages during movement.

Moreover, even in this known solution, the support bar must oscillate in a coplanar way to the arm in order to reach the positioning substantially parallel to the ground in the second condition.

Therefore, only two degrees of liberty are allowed in order to regulate the positioning of the wheels with respect to the ground in the first operating condition.

Moreover, this known solution also needs a shock absorbing mechanism to thrust the arm with respect to the frame.

One purpose of the present invention is to achieve an agricultural machine which is both simple and economic to make, and which allows to position the support bar and the star-shaped wheels in a position substantially parallel to the ground in the second transport condition, in a simple and effective way, and without compromising the adjustments, the functionality and the efficiency of the wheels in their operating condition.

Another purpose of the present invention is to achieve an agricultural machine which allows to improve the responsiveness of the arms in the operating condition, achieving a suspension and not a shock-absorption between the parts.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

In accordance with the above purposes, an agricultural machine according to the present invention is applied to rake a mass of hay, or other agricultural product, so as to form a relative tier.

The agricultural machine according to the invention comprises at least a trailer-mounted frame able to be connected to a traction means, such as for example a tractor or other.

The agricultural machine also comprises at least an arm on which a plurality of operating tools are mounted rotatably.

The arm is constrained to the frame so as to be able to be moved selectively between a first operating condition in which the operating tools are kept in cooperation with the ground, at a determinate angle of incidence, so as to carry out a desired thrust action on the mass of hay, and a second inactive or transport condition, in which the operating tools are kept raised from the ground in a position substantially parallel to the ground itself.

According to a characteristic feature of the present invention, the machine comprises articulation means, interposed between the frame and the arm, to define the constraint between the two.

The articulation means comprise a first positioning portion attached to the frame and a second positioning portion to which the arm is constrained. The first positioning portion and the second positioning portion are pivoted to each other by means of an articulation pin, which defines a relative pivoting axis. In this way it is possible to allow the arm to move between the two conditions, operating and inactive, with respect to the pivoting axis.

The articulation means, interposed between the frame and the arm, allow to release the direct pivoting of the arm to the frame with consequent advantages in terms of replacing parts and simplified maintenance interventions, and also the possibility of widening laterally the radius of action of the agricultural machine given the same forces acting on the pin.

In particular, the first positioning portion is attached to the frame by means of attachment means, so as to keep the articulation pin with its pivoting axis inclined both by a determinate first angle of inclination with respect to a first reference plane substantially vertical to a direction of movement of the frame, and also a determinate second angle of inclination with respect to a second reference plane substantially horizontal to the direction of movement of the frame.

The pivoting of the first and second positioning portion is such that the inclination at which the first positioning portion is attached is transferred to the second positioning portion too.

In this way, the articulation pin that articulates the first positioning portion and the second positioning portion has its pivoting axis substantially inclined both with respect to a substantially horizontal plane and also with respect to a substantially vertical plane.

Therefore, with the present invention, the arm is pivoted in a substantially inclined manner with respect to the frame, even if it cooperates in a substantially orthogonal and optimum manner with the articulation pin, since the articulation occurs between the first and second positioning portion, which are both inclined with respect to the frame.

In this way we obtain substantially traditional conformations, sizes, wear and kinematic actions of the articulation pin, even though the inclined rotation of the arm with respect to the frame is guaranteed.

Furthermore, the inclined disposition of the first positioning portion with respect to the frame allows to keep the arm in a condition such that it is possible to achieve a shock absorption of the latter in suspension, for example attaching a suspension mechanism between the second positioning portion and the arm.

This solution is mechanically more efficient than the thrust type shock absorption solutions necessary in known embodiments, also guaranteeing a better reactivity in the suspension response and less wear for the components provided.

Another advantage of the solution according to the present invention is that a possible support bar for the tools is completely unconstrained from the movement of the arm between said two conditions, and it is thus possible to provide greater margins of freedom and regulation of the position of the wheels.

In fact, in a variant in which the operating tools are rotatably mounted on a support bar, in turn constrained to the arm, the support bar can be mounted rotatable on an external end of the arm and can oscillate in a non-coplanar manner to the arm.

This solution allows the support bar, and consequently the operating tools, to adapt as much as possible to the irregularities of the ground, thus carrying out a more accurate work and stressing the suspension mechanisms as little as possible.

According to a variant, the first positioning portion comprises, at least partly, relative tubular elements to support relative tired wheels of the trailer-mounted frame.

In this way, the position of the wheels is widened with respect to traditional solutions, and bigger tires can be mounted, giving greater stability to the frame in pulling and working conditions, even at higher speeds.

This advantage also allows to extend the surface of a central part of the frame, with a variant providing a housing portion for a spare wheel.

According to a variant, both the first angle of inclination and the second angle of inclination have an amplitude comprised between about 5° and about 25°, advantageously between about 10° and about 20°.

According to a variant, the first angle of inclination is substantially equivalent to the second angle of inclination.

According to a variant, the first angle of inclination and the second angle of inclination are different.

According to a variant, the attachment means comprise a first attachment plate mounted on the frame, so that an attachment surface thereof defines the first angle with the direction of movement, and a second attachment plate mounted on the first positioning portion and inclined axially by the second angle with respect to a longitudinal axis of the first positioning portion.

According to another variant, applicable to all the alternative solutions provided, each operating tool comprises a star-shaped wheel consisting of a plurality of radial teeth able to effect the elastic thrust action on the hay.

In particular, each radial tooth is made of metal and has a determinate elasticity. The star-shaped wheel thus formed acts in a known manner on the hay so as to turn it over and rake it in order to pile it up to form the tier.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a three-dimensional view of an agricultural machine for raking hay according to the present invention, in a first operating condition;

FIG. 2 is a view from above of the agricultural machine in FIG. 1;

FIG. 3 is an enlarged detail of the agricultural machine in FIG. 1;

FIG. 4 is a three-dimensional view of an agricultural machine for raking hay according to the present invention, in a second inactive condition, or for transport;

FIG. 5 is a side view of the agricultural machine in FIG. 4;

FIG. 6 is a view from above of the agricultural machine in FIG. 4;

FIG. 7 is an exploded view of part of the agricultural machine according to the present invention;

FIG. 8 is a three-dimensional view of part of the machine shown in FIG. 7;

FIG. 9 is a plane view of the part of the machine shown in FIG. 8;

FIG. 10 is a side view of part of the machine shown in FIG. 9.

### DETAILED DESCRIPTION OF A PREFERENTIAL FORM OF EMBODIMENT

With reference to the attached drawings, an agricultural machine or swather 10 according to the present invention is able to be pulled by a tractor, of the known type and not shown here, to form a tier of hay.

The swather 10 comprises a trailer-mounted frame 11, on which a plurality of star-shaped wheels 12 are mounted, which effect an action of raking and turning over the hay to define the tier.

In particular, the frame 11 comprises a central part 13, the front extension of which is suitable to be attached to the tractor.

The machine 10 also comprises two arms, respectively 15a and 15b, constrained on opposite sides to the central part 13 by means of two positioning portions 19a and 19b articulated to each other by means of an articulation pin 14 defining a pivoting axis X.

A relative support bar 17 is constrained at the external end to each arm 15a and 15b, and in turn the star-shaped wheels 12 are mounted thereon.

The constraint between the support bar 17 and the relative arm 15a and 15b is such that the support bar 17 can oscillate in a different plane from that on which the arm 15a and 15b lies, with a predefined degree of angular freedom, of a known amplitude.

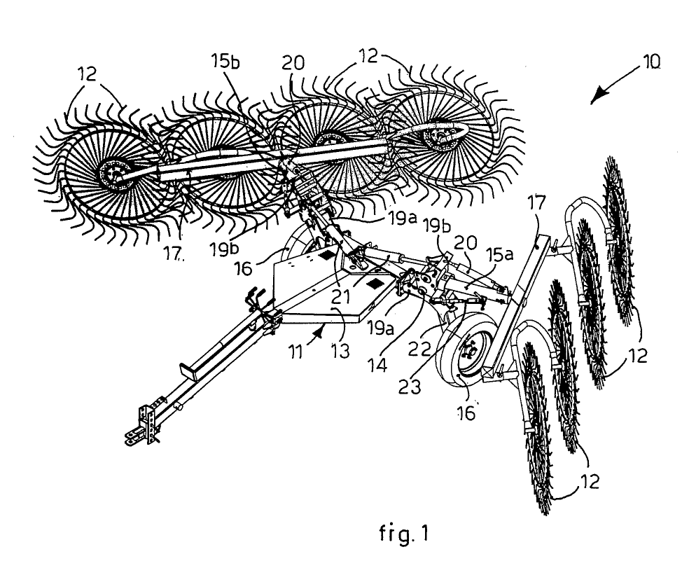

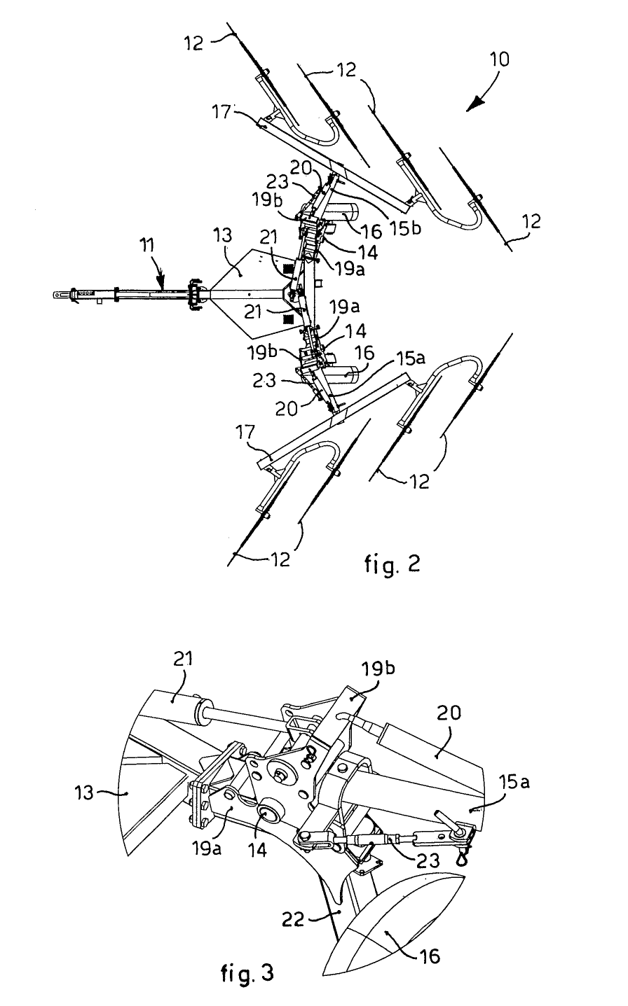

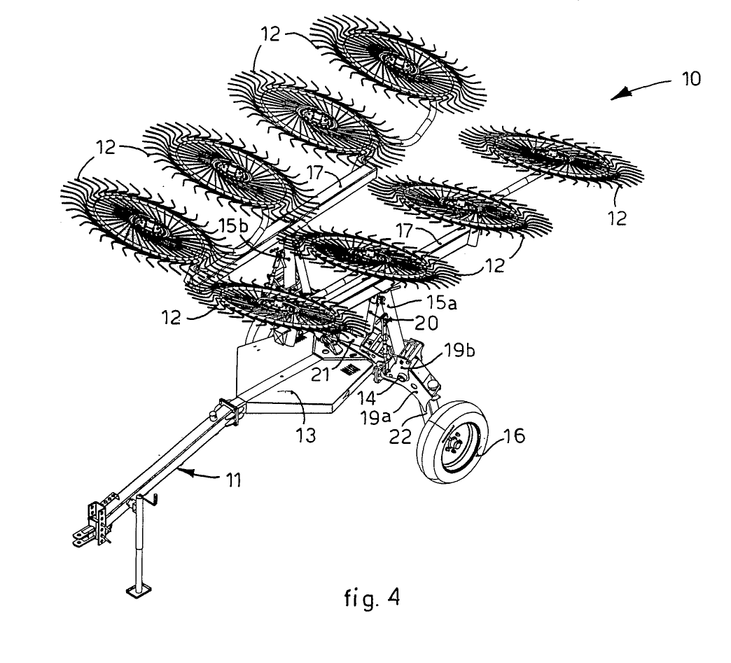

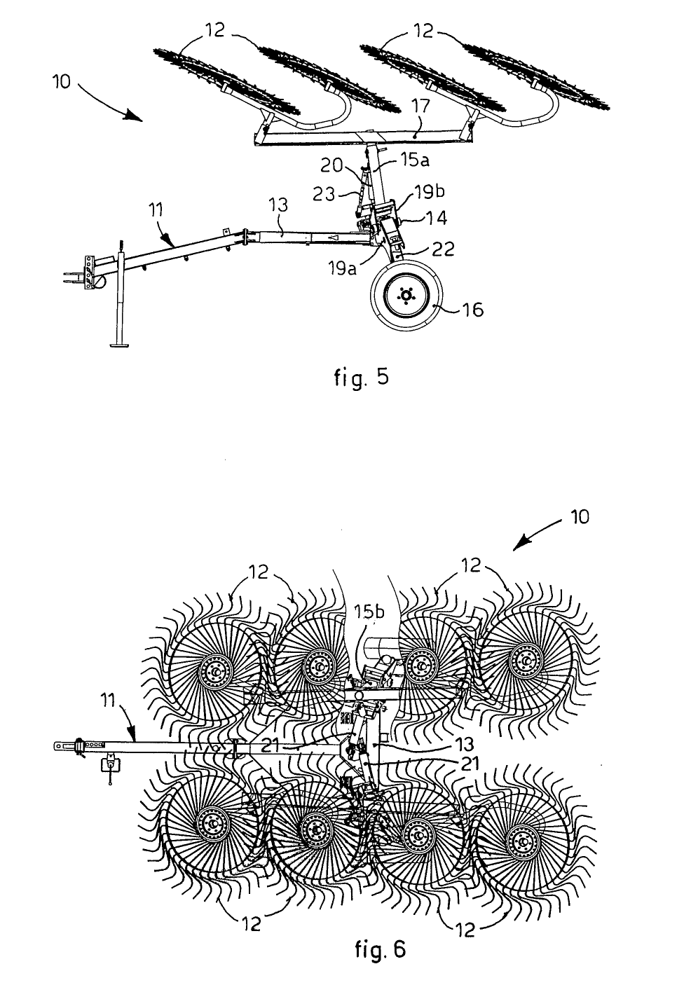

The constraint defined by the two positioning portions 19a and 19b and the articulation pin 14 allows to selectively move each arm 15a and 15b with respect to the central part 13 of the frame 11, between a first lowered operating condition (FIGS. 1 and 2), in which the star-shaped wheels 12 contact the ground and effect the action of raking and turning over the hay so as to define the tier, and a second raised inactive position (FIGS. 4, 5 and 6), in which the star-shaped wheels 12 are above the frame 11 and are in a position substantially parallel to the ground.

In particular, the first positioning portion 19a is mounted on the first part 13 of the frame 11 by the reciprocal attachment of two attachment plates, respectively a first plate 25 attached to the first part 13 and a second plate 26 attached to the first positioning portion 19a.

The relative arm 15a and 15b is mounted on the second positioning portion 19b.

The articulation pin 14 is mounted substantially orthogonal between the two positioning portions 19a and 19b, that is, with its pivoting axis X substantially orthogonal to a longitudinal plane common to the two positioning portions 19a and 19b and comprised in a plane transverse to the positioning portions 19a and 19b.

The first attachment plate 25 is mounted inclined with respect to the frame 11 and the second attachment plate 26 is mounted inclined axially on the first positioning portion 19a, so as to keep the latter not orthogonal to the frame 11 according to the following disposition.

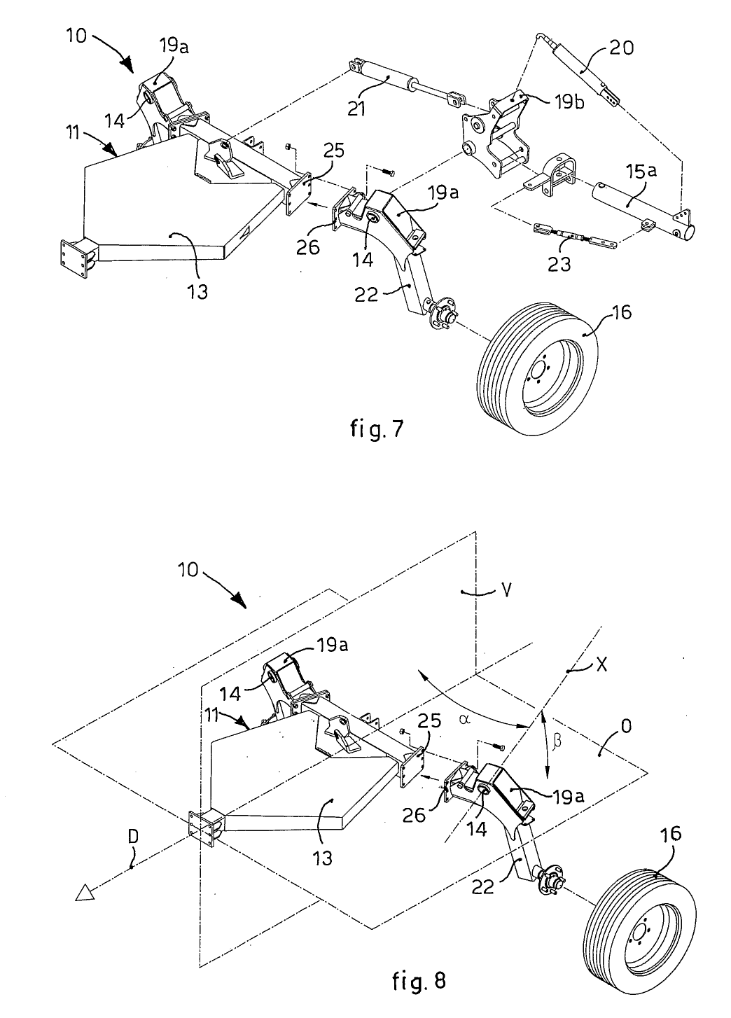

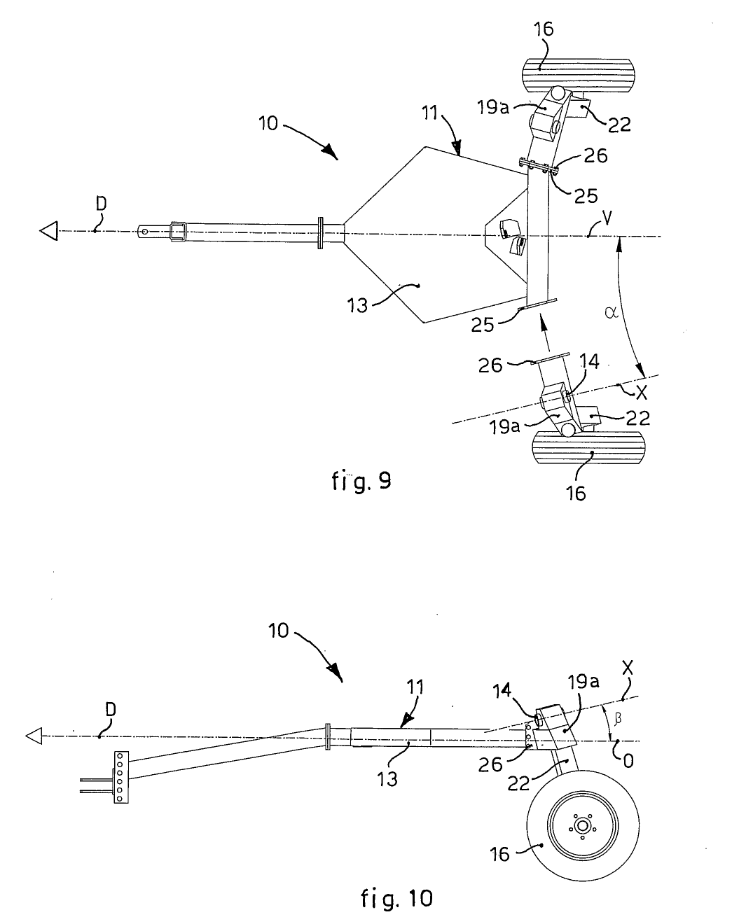

As can be seen in FIGS. 7, 8, 9 and 10, the first positioning portion 19a is disposed so that the pivoting axis X of the articulation pin 14 defines both a first angle of inclination a with respect to a first reference plane V substantially vertical to a direction of movement D, or pulling, of the frame 11, and also a second angle of inclination β with respect to a second reference plane O substantially horizontal to the direction of movement D.

In this way, the first positioning portion 19a, and consequently the second positioning portion 19b too, has a double inclination with respect to the direction of movement D, in coordination with the pivoting axis X of the articulation pin 14.

Therefore, there is a consequent conditioning of the angle of rotation of the relative arm 15a and 15b with respect to the frame 11.

The double angle thus defined is such that each arm 15a and 15b, in the first operating condition, correctly keeps the relative support bar 17 and the star-shaped wheels 12 in contact with the ground, to achieve an efficient action on the hay, and in the second operating condition, positions the support bar 17 and the star-shaped wheels 12 substantially parallel to the ground.

Furthermore, since the second positioning portion 19b and the relative arm 15a and 15b are inclined coordinately, it is possible to provide between them a suspension element 20 attached on one side to the upper part of the second positioning portion 19b and, on the other side, to the upper part of the relative arm 15a and 15b.

In this way, a shock absorption of the suspended arm 15a and 15b is achieved.

In this case, the movement of each arm 15a and 15b is actuated by means of relative linear actuators 21 attached on one side to the second positioning portion 19b and on the other side to the central part 13 of the frame 11.

In this way, the second positioning portion 19b is made to rotate with respect to the first positioning portion 19a, with respect to the articulation pin 14, so as to move the arm 15a and 15b with respect to the frame 11, between the two conditions, operating and inactive.

In this case, the arm 15a and 15b is mounted on the relative second positioning portion 19b in an articulated manner, so as to be able to be selectively moved, at least in the first operating condition, along a substantially horizontal plane, to define a desired angle of divaricating and positioning of the star-shaped wheels 12.

Advantageously, a relative tie rod 23 is associated with each arm 15a and 15b, with which the movement on the horizontal plane of the arm 15a and 15b with respect to the relative second positioning portion 19b is regulated and clamped, so as to define and regulate the desired angle of divaricating and positioning of the star-shaped wheels 12.

Furthermore, in the solution shown in the attached drawings, below each first positioning portion 19a a tubular profile 22 is mounted, to support respective tired wheels 16 to transport the frame 11.

It is clear, however, that modifications and/or additions of parts may be made to the swather 10 as described heretofore, without departing from the field and scope of the present invention.

For example, it comes within the field of the present invention to provide that the linear actuators 21 are commanded electronically, or provide other actuation mechanisms, for example cams, levers or other.

According to a variant, instead of the tie rod 23 an alternative regulation element is provided, for example electric, hydraulic, mechanical or other.

According to a variant, the first angle of inclination α and the second angle of inclination β are substantially equivalent and have an amplitude comprised between about 10° and about 20°, advantageously about 15°.

According to another variant, the first angle of inclination α and the second angle of inclination β are different from each other.

It is also clear that, although the present invention has been described with reference to some specific examples, a person of skill in the art shall certainly be able to achieve many other equivalent forms of agricultural machine for raking an agricultural product, having the characteristics as set forth in the claims and hence all coming within the field of protection defined thereby.

1. An agricultural machine to rake a mass of hay or other agricultural product, comprising at least a trailer-mounted frame having a central part and a longitudinal axis defining a direction of movement D of the frame, said frame being connectable to a traction mean, the machine further comprising at least an arm on which a plurality of operating tools are rotatably mounted, said arm being constrained to the central part of said frame so as to selectively move between a first operating condition in which said operating tools are in cooperation with the ground, and a second inactive condition in which said operating tools are raised from the ground in a position substantially parallel to the ground itself, said agricultural machine comprising articulation means, interposed between said frame and said arm and comprising a first positioning portion attached to said frame and a second positioning portion to which said arm is constrained, said first positioning portion and said second positioning portion being pivoted with respect to each other by means of an articulation pin mounted substantially orthogonal between said two positioning portions and defining a pivoting axis (X), in order to move the arm with respect to said pivoting axis (X) between the two conditions, operating and inactive, wherein the first positioning portion is mounted on the frame by means of the reciprocal attachment of two plates, a first plate being attached to said central part and a second plate being attached to said first positioning portion, wherein said first plate is mounted inclined with respect to the longitudinal axis of the frame and said second attachment plate is mounted inclined axially on said first positioning portion, whereby the articulation pin with its pivoting axis (X) is kept inclined both by a determinate first angle of inclination (α) with respect to a first reference plane (V), substantially vertical to the direction of movement (D) of said frame, and also a determinate second angle of inclination (β) with respect to a second reference plane (O) substantially horizontal to said direction of movement (D) of said frame.

2. The agricultural machine as in claim 1, further comprising a suspension mechanism disposed between the second positioning portion and the arm, in order to determine a shock absorbing condition of said arm in suspension.

3. The agricultural machine as in claim 1, further comprising a support bar on which the operating tools are rotatably mounted and which is provided constrained to the arm so as to be able to oscillate on a plane substantially orthogonal to the plane on which said arm lies.

4. The agricultural machine as in claim 1, wherein the first positioning portion comprises at least a tubular element to support relative transport wheels of the frame.

5. The agricultural machine as in claim 1, wherein the arm is constrained to the second positioning portion in an articulated manner, so as to be able to be selectively moved, at least in the first operating condition, on a substantially horizontal plane, to define a desired angle of divaricating and positioning of the operating tools.

6. The agricultural machine as in claim 5, wherein with the arm a regulation element is associated, with which the movement on the horizontal plane of said arm is regulated and clamped with respect to the relative second positioning portion.

7. The agricultural machine as in claim 6, wherein the regulation element is a tie rod.

8. The agricultural machine as in claim 6, wherein the regulation element is an electric, hydraulic, mechanical or other actuator.

9. The agricultural machine as in claim 1, further comprising two arms constrained on opposite sides of the frame.

10. The agricultural machine as in claim 1, wherein the first angle of inclination (α) and the second angle of inclination (β) have a substantially equivalent amplitude, comprised between about 5° and about 25°.

11. The agricultural machine as in claim 10, wherein the first angle of inclination (α) and the second angle of inclination (β) have an amplitude comprised between about 10° and about 20°.

12. The agricultural machine as in claim 1, wherein the first angle of inclination (α) and the second angle of inclination (β) are different from each other.

13. (canceled)
